(19) United States
(12) Patent Application Publication
(10) Pub. No.: US 2022/0229755 A1
(43) Pub. Date: Jul. 21, 2022

(54) DOCKING STATIONS HEALTH

(71) Applicant: Hewlett-Packard Development Company, L.P., Spring, TX (US)

(72) Inventors: Ravindra Ramtekkar, Pune (IN); Narendra Kumar Chincholikar, Pune (IN)

(21) Appl. No.: 17/683,528

(22) Filed: Mar. 1, 2022

(30) Foreign Application Priority Data
Jan. 16, 2021 (IN) 202141002119

(51) Int. Cl. G06F 11/30

(52) U.S. Cl. CPC G06F 11/3051; G06F 11/3055

(57) ABSTRACT

An example of an electronic device includes a processor to collect data of an input/output (I/O) interface of a docking station to which the electronic device is to couple, use at least one artificial intelligence (AI) processing model to process the collected data of the I/O interface to provide an AI processing model result that calculates past usage and predicts future usage of the I/O interface, and determine an estimated health of the docking station based on the AI processing model result.

### BACKGROUND

Computing devices, such as notebook computers, tablet devices, smartphones, etc. can couple to a docking station. The docking station may include connectivity options that enhance usability of the computing devices, such as additional ports for connecting peripherals, etc.

### BRIEF DESCRIPTION OF THE DRAWINGS

Various examples are described below referring to the following figures:

FIG. 1 is a computing environment in accordance with various examples.

FIG. 2 is an electronic device in accordance with various examples.

FIG. 3 is a flowchart of a method for determining docking station health in accordance with various examples.

FIG. 4 is a flowchart of a method for determining docking station health in accordance with various examples.

FIG. 5 is a flowchart of a method for determining docking station health in accordance with various examples.

### DETAILED DESCRIPTION

As explained above, a docking station for a computing device may include connectivity options that enhance usability of the computing device, such as additional ports for connecting peripherals, etc. Over time, the docking station may begin to degrade in performance. For example, ports of the docking station may fail, components of the docking station such as a battery may degrade in performance (e.g., a capacity of the battery may decrease), etc. A user may be unaware of impending failure or degraded performance of a docking station until the user attempts to use the docking station, and the docking station fails to function as designed. Thus, the user may be left without a properly-functioning docking station for a prolonged period to allow for repair or replacement of the faulty docking station. Unawareness of the health of a docking station may be exacerbated in shared working environments in which the user is unaware of how often, or to what degree, a docking station is used because of the user's transient nature with respect to the docking station.

This disclosure describes a process for assessing a current health of a docking station and predicting a future health of the docking station. In at least some examples, a computing device communicatively coupled to a docking station includes a data capture application. The data capture application captures data associated with the docking station, such as a time of insertion of a plug into a port of the docking station (and therefore a number of insertions of plugs into the port), a time of removal of the plug from the port of the docking station, and various usage statistics such as average number of ports used, average duration of port usage, etc. The computing device implements an artificial intelligence (AI) model to process the captured data. The AI model may be, for example, a time series model and/or an autoregressive fractionally integrated moving average (ARIMA) model. Based on the processing, the computing device may determine an estimated health of the docking station. The computing device may further determine a projected, or future health of the docking station. Based on the estimated health of the docking station, or the projected health of the docking station, the computing device may take action. For example, the computing device may generate and provide a notification, may submit a work order for repair or replacement of the docking station, etc.

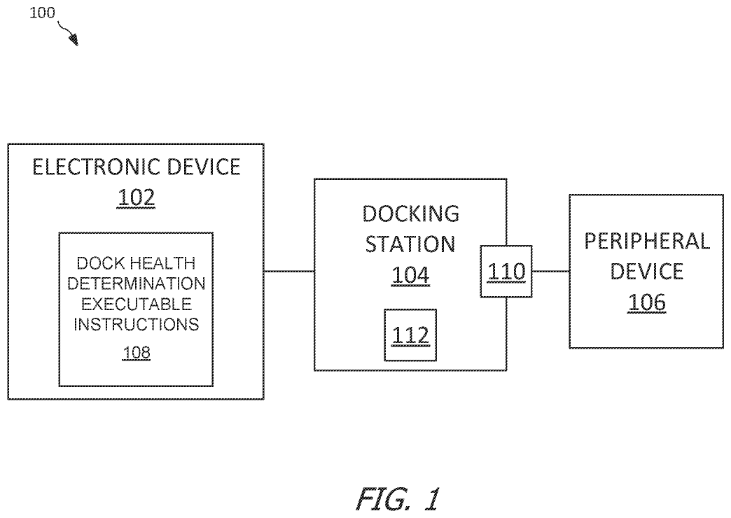

FIG. 1 is a block diagram depicting an example computing environment 100. In at least some examples, the computing environment 100 includes an electronic device 102, a docking station 104, and a peripheral 106. The electronic device 102 includes, in some examples, dock health determination executable instructions 108. Executable instructions, in at least some examples, may also be referred to as executable code, or machine-executable code. The docking station 104 includes, in some examples a port 110. Although one port 110 is shown in FIG. 1, in various examples the docking station 104 may include any number of ports, where some of the ports may have a same, or substantially same, functionality and some of the ports may have a different functionality. In at least some examples, the docking station 104 also includes a battery 112. The peripheral 106 may be any device that includes a plug (not shown) that interfaces with the port 110 to provide functionality of the peripheral 106 to the electronic device 102 if the docking station 104 is coupled to the electronic device 102. In at least some examples, the docking station 104 and/or the peripheral 106 are plug-and-play (PnP) devices.

In some examples, the electronic device 102 is a laptop computer, a netbook, a notebook computer, a tablet computer, a smartphone, or any other suitable device for which functionality may be extended by coupling, or docking, the electronic device 102 to the docking station 104. In at least some examples, the electronic device 102 is docked to the docking station 104 via a wireless or wired coupling capable of supporting data transmission between the electronic device 102 and the docking station 104. An application (not shown) may execute on the electronic device 102 that collects data associated with the docking station 104 while the electronic device 102 is docked to the docking station 104. Based on that collected data, the electronic device 102 may determine a current health of the docking station 104 and/or a prediction of future health of the docking station 104. As used herein, health of the docking station 104 (or any other docking station) may mean whether, or to what degree, the docking station 104 is operating according to manufacturer's specifications, and in comparison, to operation or functionality of the docking station 104 when the docking station 104 was new (e.g., considered healthy). For example, it may be assumed that if the docking station 104 is used in a regular manner, beginning at a day 1 and continuing to a day 100, the health of the docking station 104 at day 100 will be less than the health of the docking station 104 at day 1.

For example, the electronic device 102 may implement a machine learning (ML) or AI process to analyze the collected data. The AI process may be, for example, a time series model. The time series model may predict the health of the docking station 104, current and/or future, based on the collected data. In this disclosure it is assumed that the AI process (e.g., the time series model) has been previously, and accurately, trained such that the AI process of this disclosure is as occurs at runtime. In some examples, the collected data relates to input/output (I/O) interfaces of the docking station 104. For example, each interface (e.g., port) of the docking station 104 to which the peripheral 106 (or other peripherals) may couple may be considered an I/O interface. By collecting data related to the usage of the I/O interfaces, and processing that collected data via the AI process, the health of the docking station 104 may be determined (e.g., estimated and/or predicted). In at least some examples, collected data may relate to a time when usage of a particular I/O interface began, a time when usage of the particular I/O interface ended, a number of I/O interfaces provided by the docking station 104, and/or various other data that may be derived from the above.

For example, derived data may include a number of I/O interfaces active (e.g., being used) at a given time, an I/O interface usage time (e.g., difference between the time when usage of the particular I/O interface began and the time when usage of the particular I/O interface ended for a particular interaction with the particular I/O interface), a number of insertions and/or removals of a connector from a particular I/O interface, an overall active time of the docking station 104, an overall port usage percentage of the docking station 104 (e.g., a ratio of the overall active time of the docking station 104 to a mean of the I/O interface usage time for each I/O interface of the docking station 104). Further derived data, such as may be determined by the AI process or based on an output of the AI process, may include a dock health score indicating a current estimated or determined health of the docking station 104, a probability score that indicates a probability that the docking station 104 should be replaced, and a dock performance score that is an average of the overall port usage percentage. For example, if the docking station 104 includes 5 I/O interfaces, of which 3 are active for 14 hours in a day and 2 are inactive, the dock performance score may be determined by a sum of the number of hours that each I/O interfaces is active, divided by the total number of I/O interfaces of the docking station 104. In this example, the dock performance score may be determined according to (14*3)/5 or (14+14+14)/5.

Although not specifically referred to herein as derived data, in at least some examples the collected data (e.g., such as the I/O interface beginning and ending usage times) may be derived from other data, such as whether power is provided to the I/O interface or any other suitable data provided to the electronic device 102. In some examples, at least some of the collected data or the derived data is weighted differently in the AI process, such that some may contribute more to the estimated or determined health of the docking station 104 than other of the collected data or the derived data. For example, collected data or derived data associated with functions or I/O interfaces of the docking station 104 that may be determined to be more useful to operation of the docking station 104 than other functions or I/O interfaces of the docking station 104 may be assigned a higher weighted value than collected data or the derived data for these other functions or I/O interfaces.

In at least some examples, the electronic device 102 may track or monitor data for PnP devices that are communicatively coupled to the electronic device 102. This monitored data can include general attributes such as a serial number of the PnP device, a product identifier of the PnP device, a universally unique identifier (UUID), such as a ClassGUID, of the of the PnP device, a model of the PnP device, whether the electronic device 102 currently detects communicative coupling to the PnP device, a name of the PnP device, a service of the PnP device, and/or an identifier of the of the PnP device. The monitored data can also include other general attributes such as an identifier of a parent device of the of the PnP device, a status of the PnP device, a PnP device class of the PnP device, a manufacturer of the PnP device, a hardware identifier of the PnP device, a firmware version of the PnP device, a power status of the PnP device, whether a driver is detected for the PnP device, a version of the driver, and/or information about the driver. At least some of the monitored data may form the basis for at least some of the collected data and/or derived data, discussed above. In at least some examples, at least some elements of the monitored data are normalized to a percentage value before processing for use by the AI process, such as to account for and/or negate variations caused by differing procedures of various PnP device manufacturers.

In at least some examples, based on the past usage of the docking station 104, such as represented through historical (e.g., daily) records of at least some of the general attributes and/or derived attributes, current health of the docking station 104 may be determined. In at least some examples, based on the past usage of the docking station 104, such as represented through historical (e.g., daily) records of at least some of the general attributes and/or derived attributes, the AI process may predict or estimate usage of the docking station 104 for a future period of time (e.g., such as about 10 days, or any other programmed time period). Based on the predicted usage, a date on which the docking station 104 may go out of order (e.g., health of the docking station 104 falls below a threshold amount) may be predicted. For example, the AI process may predict values of derived attributes for the docking station 104 based on the past usage of the docking station 104 (and, in some examples, crowdsourced data), for the future period of time. The AI process may predict the values for a programmed number of upcoming, consecutive days. In an example, a predicted value may be at a position X in the series of predicted values provided by the AI process and may be less than a threshold amount. The electronic device 102 may determine that the docking station 104 may go out of order or cease to function according to manufacturer's specifications or design on a future date corresponding to a current date plus X days.

In at least some examples, the electronic device 102 may act based on the outputs of the AI process (e.g., the past usage and/or the predicted usage) and/or the predicted out of order date. For example, the electronic device 102 may provide a notification to a user of the electronic device 102 and/or the electronic device 102 may provide a notification to a manager responsible for maintenance of the docking station 104. In at least one implementation, the electronic device 102 may generate a work order for servicing the docking station 104, the electronic device 102 may place a request to have a replacement docking station delivered from a storage location no later than the predicted out of order date, the electronic device 102 may place a request to have a replacement component for the docking station 104 delivered from a storage location no later than the predicted out of order date, and/or the electronic device 102 may perform other acts that may mitigate effects of the docking station 104 going out of order on operation of the electronic device 102. In yet further examples, the electronic device 102 may provide recommendations to a user of the electronic device 102, such as to disconnect the peripheral 106 from the docking station 104 if usage of the peripheral 106 has not met a threshold amount (e.g., used for less than a threshold amount of time in a threshold period of time), and/or the electronic device 102 may automatically take action, such as removing power from the peripheral 106 (or providing a control message to cause the docking station 104 to remove power from the peripheral 106) if usage of the peripheral 106 has not met a threshold amount.

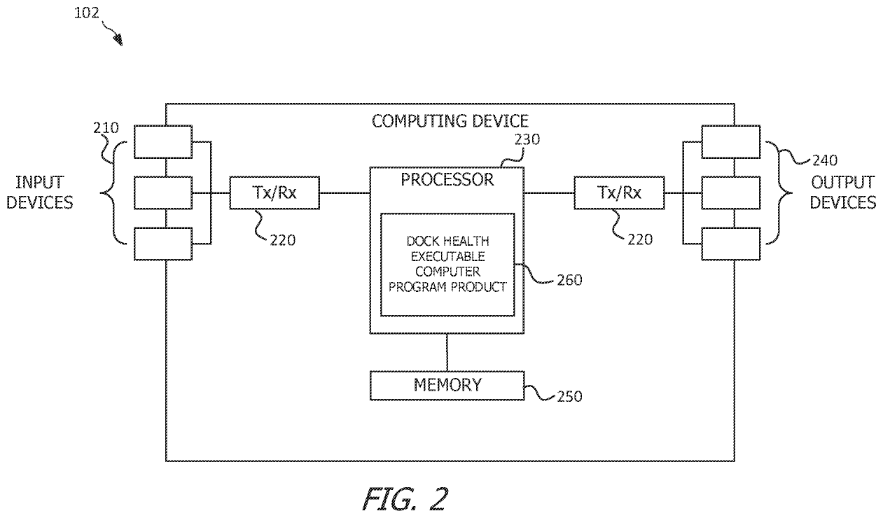

FIG. 2 is a is a block diagram depicting an example of the electronic device 102 in more detail. Electronic device 102 may be any suitable computing or processing device capable of performing the functions disclosed herein such as a computer system, a laptop device, a tablet device, a smartphone, a personal computer, etc. Electronic device 102 implements at least some of the features/methods disclosed herein, for example, as described above with respect to the computing environment 100 and/or as described below with respect to any of the method 300, method 400, and/or method 500.

The electronic device 102 comprises input devices 210. Some of the input devices 210 may be microphones, keyboards, touchscreens, buttons, toggle switches, cameras, sensors, and/or other devices that allow a user to interact with, and provide input to, the electronic device 102. Some other of the input devices 210 may be downstream ports coupled to a transceiver (Tx/Rx) 220, which are transmitters, receivers, or combinations thereof. The Tx/Rx 220 transmits and/or receives data to and/or from other computing devices via at least some of the input devices 210. The electronic device 102 also comprises a plurality of output devices 240. Some of the output devices 240 may be speakers, a display screen (which may also be an input device such as a touchscreen), lights, or any other device that allows a user to interact with, and receive output from, the electronic device 102. At least some of the output devices 240 may be upstream ports coupled to another Tx/Rx 220, wherein the Tx/Rx 220 transmits and/or receives data from other nodes via the upstream ports. The downstream ports and/or the upstream ports may include electrical and/or optical transmitting and/or receiving components. In another example, the electronic device 102 comprises antennas (not shown) coupled to the Tx/Rx 220. The Tx/Rx 220 transmits and/or receives data from other computing or storage devices wirelessly via the antennas. In yet other examples, the electronic device 102 may include additional Tx/Rx 220 such that the electronic device 102 has multiple networking or communication interfaces, for example, such that the electronic device 102 may communicate with a first device using a first communication interface (e.g., such as via the Internet) and may communicate with a second device using a second communication interface (e.g., such as another electronic device 102 without using the Internet).

A processor 230 is coupled to the Tx/Rx 220 and at least some of the input devices 210 and/or output devices 240 and implements the AI process described herein, such as via a dock health executable computer program product 260. In an example, the processor 230 comprises multi-core processors and/or memory modules 250, which function as data stores, buffers, etc. The processor 230 is implemented as a general processor or as part of application specific integrated circuits (ASICs), field-programmable gate arrays (FPGAs), and/or digital signal processors (DSPs). Although illustrated as a single processor, the processor 230 is not so limited and may comprise multiple processors.

FIG. 2 also illustrates that a memory module 250 is coupled to the processor 230 and is a non-transitory medium to store various types of data. Memory module 250 comprises memory devices including secondary storage, read-only memory (ROM), and random-access memory (RAM). The secondary storage may comprise of disk drives, optical drives, solid-state drives (SSDs), and/or tape drives and is used for non-volatile storage of data and as an over-flow storage device if the RAM is not large enough to hold all working data. The secondary storage is used to store programs that are loaded into the RAM when such programs are selected for execution. The ROM is used to store instructions and perhaps data that are read during program execution. The ROM is a non-volatile memory device that may have a small memory capacity relative to the larger memory capacity of the secondary storage. The RAM is used to store volatile data and perhaps to store instructions. Access to both the ROM and RAM may be faster than to the secondary storage.

The memory module 250 may be used to house the instructions for carrying out the various examples described herein. For example, the memory module 250 may comprise the dock health executable computer program product 260, which is executed by processor 230.

It is understood that by programming and/or loading executable instructions onto the electronic device 102, at least one of the processor 230 and/or the memory module 250 are changed, transforming the electronic device 102 in part into a particular machine or apparatus, for example, a dock health monitoring device having the novel functionality taught by the present disclosure.

In at least some examples, the dock health executable computer program product 260 includes executable instructions to cause the electronic device 102 to determine a health of the docking station 104. The health of the docking station 104 may be a current determined or estimated health, a future or projected health, and/or a projected date of failure of the docking station 104. The docking station 104 may be viewed by the electronic device 102 as a hub device to which the peripheral 106, or other devices, may couple. The docking station 104 may in turn couple to the electronic device 102 to provide connectivity between the peripheral 106 and the electronic device 102. In at least some examples, the electronic device 102 detects and/or collects general attributes about the peripheral 106 while the peripheral 106 is coupled to the docking station 104 and the docking station 104 is coupled to the electronic device 102. In at least some examples, the general attributes may include a serial number of the peripheral 106, a product identifier of the peripheral 106, a UUID, such as a ClassGUID, of the of the peripheral 106, a model of the peripheral 106, whether the electronic device 102 currently detects communicative coupling to the peripheral 106, a name of the peripheral 106, a service of the peripheral 106, and/or an identifier of the of the peripheral 106. The general attributes may also include an identifier of a parent device of the of the peripheral 106, a status of the peripheral 106, a PnP device class of the peripheral 106, a manufacturer of the peripheral 106, a hardware identifier of the peripheral 106, a firmware version of the peripheral 106, a power status of the peripheral 106, whether a driver is detected for the peripheral 106, a version of the driver, and/or information about the driver.

In at least some examples, based on the instructions of the dock health executable computer program product 260, the electronic device 102 determines derived attributes based at least in part on the general attributes. The derived attributes may include a time when the peripheral 106 was detected by the electronic device 102, a time when the peripheral 106 was no longer detected by the electronic device 102, a number of I/O interfaces provided by the docking station 104, a number of I/O interfaces of the docking station 104 that are active (e.g., being used) at a given time, an I/O interface usage time (e.g., difference between the time when the peripheral 106 was detected to the time when the peripheral 106 was no longer detected), and/or a number of insertions and/or removals of a connector from a particular I/O interface. The derived attributes may also include an overall active time of the docking station 104, an overall port usage percentage of the docking station 104 (e.g., a ratio of the overall active time of the docking station 104 to a mean of the I/O interface usage time for each I/O interface of the docking station 104). In at least some examples, the derived attributes may also include a previously determined health of the docking station 104, a previously determined probability score that indicates a probability that the docking station 104 should be replaced, and/or a dock performance score of the docking station 104.

In at least some examples, based on the instructions of the dock health executable computer program product 260, the electronic device 102 implements an AI process that includes a time series model to determine the dock health and/or the probability score. For example, the general attributes and the derived attributes (or at least some of the general attributes and/or the derived attributes) described above may be inputs to the time series model and the dock health and/or the probability score may be outputs of the time series model. In some examples, the electronic device 102 determines a time at which the peripheral 106 is coupled to, or decoupled from, the electronic device 102 based on the general attribute indicating whether the electronic device 102 detects the peripheral 106. For example, responsive to the peripheral 106 being coupled to the docking station 104 and the docking station 104 being coupled to the electronic device 102, the electronic device 102 detects the peripheral 106 as being present. Responsive to the peripheral 106 being decoupled from the docking station 104 or the docking station 104 being decoupled from the electronic device 102 while the peripheral 106 is still coupled to the docking station 104, the electronic device 102 detects the peripheral 106 as no longer being present.

In some examples, the electronic device 102 may transmit at least some of the general attributes, the derived attributes, the dock health, and/or the probability score to a data store. The data store may be, for example, a cloud server or cloud data store. The data store may store data from multiple electronic devices captured from multiple docking stations. The data may be transmitted at any programmed interval, such as once daily, once weekly, once every programmed number of hours, etc. In at least some examples, the data may be grouped based on similarity of the docking stations, such that trends or other data regarding the docking stations may be provided as crowdsourced data. Crowdsourced data may include data for several, different docking stations. For example, similar docking stations may be docking stations that have a same model number, were made in a same manufacturing batch, include a particular component from a particular vendor, include components from a particular manufacturing batch of a particular vendor, and/or are rated for approximately equivalent performance. The crowdsourced data, in some examples, may correlate general attributes, derived attributes, and health of the docking stations. Based on the crowdsourced data, insights may be gained into the docking station 104 when the docking station 104 is similar to docking stations from which the crowdsourced data originated. For example, if at least docking stations similar to the docking station 104 and having data in the crowdsourced data failed at a similar time and with similar attribute sets, the electronic device 102, via the dock health executable computer program product 260, may estimate that the docking station 104 will also fail at the similar time and/or with the similar attribute set.

In an example of the AI process implemented according to the dock health executable computer program product 260, the time series model of the AI process predicts future values based on current and/or past values. For example, based on at least some of the general attributes and/or the derived attributes, the AI process determines future values for at least some of the general attributes and/or the derived attributes. For example, the AI process may determine a next ten consecutive dock performance values. Based on the dock performance values, the AI process may determine the health of the docking station 104 and the probability score. In some examples, the health of the docking station 104 has a maximum value of 100, such as when the docking station 104 is in new condition or has not yet been used. In some examples, responsive to determining the health of the docking station 104 to have a value greater than about 80, the electronic device 102 may indicate that the docking station 104 is functioning properly and at current usage rates may continue functioning properly for a determined number of days. Responsive to determining the health of the docking station 104 to have a value greater than about 50 and less than about 80, the electronic device 102 may indicate that the docking station 104 is degraded and at current usage rates may need replacement in a determined number of days. Responsive to determining the health of the docking station 104 to have a value less than about 50, the electronic device 102 may indicate that the docking station 104 is degraded and may need imminent replacement. While certain health values, thresholds, and ranges are described above, in various examples these values, thresholds, and ranges may each be any suitable number, such as determined according to a use case or use environment of the docking station 104.

In at least some examples, the electronic device 102 may provide certain recommendations, notifications, and/or take certain actions based on the determined health of the docking station 104. For example, the electronic device 102 may provide a notification to a user indicating the health of the docking station 104, may provide a notification to the user indicating the determined number of days until recommended replacement of the docking station 104, and/or may provide other recommendations or notifications to the user based on the general attributes, the derived attributes, and/or a result of the AI process. In other examples, the electronic device 102 may take action based on the result of the AI process. For example, the electronic device 102 may generate, transmit, and/or provide a work order to schedule repair and/or replacement of the docking station 104 responsive to determining the number of days until recommended replacement of the docking station 104. In another example, the electronic device 102 may generate, transmit, and/or provide an order to a storage location for delivery of a replacement docking station responsive to determining the number of days until recommended replacement of the docking station 104.

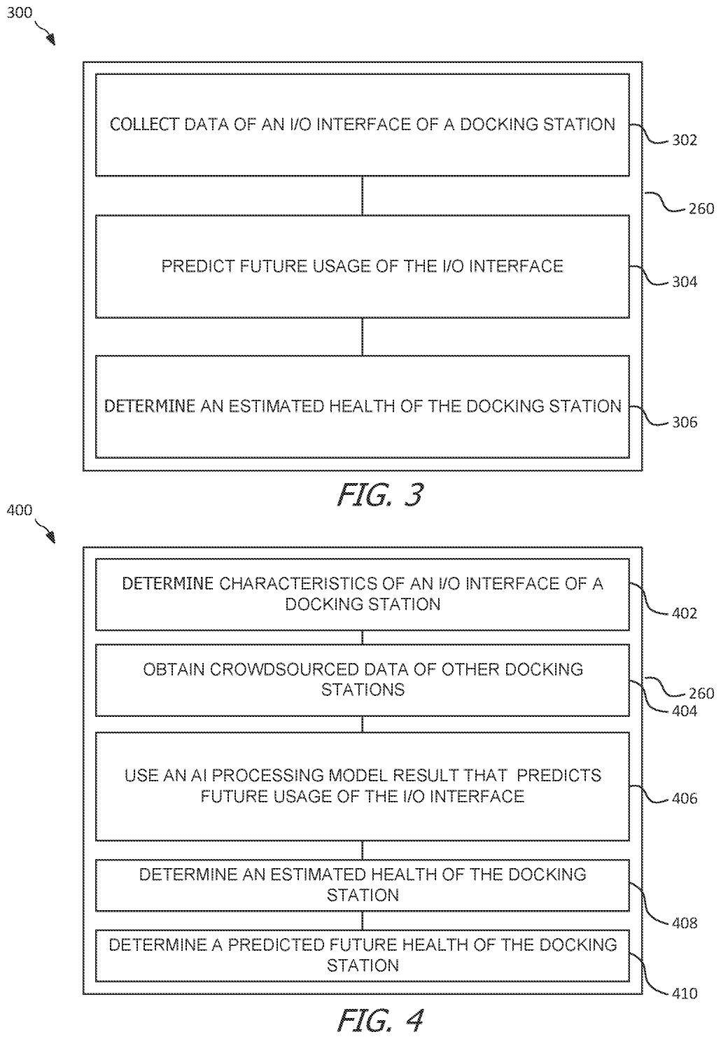

FIG. 3 is a flowchart of an example method 300 for dock health determination. In at least some examples, the method 300 is suitable for implementation on an electronic device, such as the electronic device 102 of the computing environment 100 of FIG. 1. For example, in at least some implementations the method 300 may be embodied as the dock health executable computer program product 260. Accordingly, the method 300 may be implemented as computer-executable instructions or code, stored on a computer-readable medium, such as the memory module 250 of FIG. 2, which, when executed by a processor such as the processor 230 of FIG. 2, causes the processor 230 to execute the computer-executable instructions to perform operations. The method 300 is implemented by the electronic device, in some examples, to determine a health of a docking station coupled to the electronic device.

At operation 302, the electronic device collects data of an I/O interface of a docking station to which the electronic device is to couple. The data may be collected, in some examples, as the general attributes and/or the derived attributes of a peripheral device coupled to the docking station, as described above herein. In some examples, the electronic device determines the derived attributes based on the general attributes for each peripheral device coupled to the docking station, and correspondingly each respective I/O interface of the docking station to which one of the peripheral devices is uniquely coupled.

At operation 304, the electronic device uses at least one AI processing model to process the collected data of the I/O interface to provide an AI processing model result that calculates past usage and predicts future usage of the I/O interface. In at least some examples, the AI processing model is a time series model, such as ARIMA. Based on the collected data, the AI process may determine predicted future values for the docking station.

At operation 306, the electronic device determines an estimated health of the docking station based on the AI processing model result. In at least some examples, the estimated health is determined based on the predicted future values for the docking station. The estimated health may be represented, in some examples, on a scale from 0 to 100, where a value of 100 is considered a maximum health of the docking station (e.g., such as when the docking station is new and/or as of yet unused). In other examples, the estimated health may be represented as an estimated number of days until recommended replacement of the docking station.

FIG. 4 is a flowchart of an example method 400 for dock health determination. In at least some examples, the method 400 is suitable for implementation on an electronic device, such as the electronic device 102 of the computing environment 100 of FIG. 1. For example, in at least some implementations the method 400 may be embodied as the dock health executable computer program product 260. Accordingly, the method 400 may be implemented as computer-executable instructions or code, stored on a computer-readable medium, such as the memory module 250 of FIG. 2, which, when executed by a processor such as the processor 230 of FIG. 2, causes the processor 230 to execute the computer-executable instructions to perform operations. The method 400 is implemented by the electronic device, in some examples, to determine a health of a docking station coupled to the electronic device.

At operation 402, the electronic device determines characteristics of an I/O interface of a docking station to which the electronic device is coupled. The characteristics may be collected, in some examples, as the general attributes and/or the derived attributes of a peripheral device coupled to the docking station, as described above herein. In some examples, the electronic device determines the derived attributes based on the general attributes for each peripheral device coupled to the docking station, and correspondingly each respective I/O interface of the docking station to which one of the peripheral devices is uniquely coupled.

At operation 404, the electronic device obtains crowdsourced data of other docking stations sharing at least one attribute with the docking station. In at least some examples, the crowdsourced data is obtained from a network-based source, such as a cloud-based data store. The crowdsourced data, in some examples, may correlate general attributes, derived attributes, and health of the docking stations.

At operation 406, the electronic device may use at least one AI processing model to process the determined characteristics of the I/O interface and/or the crowdsourced data to provide an AI processing model result that calculates past usage and predicts future usage of the I/O interface. In at least some examples, the AI processing model is a time series model, such as ARIMA. Based on the determined characteristics of the I/O interface and/or the crowdsourced data, the AI process may determine predicted future values for the docking station.

At operation 408, the electronic device may determine an estimated health of the docking station based on the AI processing model result. In at least some examples, the estimated health of the docking station is determined as a value on a scale of 0 to 100 where a value of 100 is considered a maximum health of the docking station (e.g., such as when the docking station is new and/or as of yet unused).

At operation 410, the electronic device may determine a predicted future health of the docking station based on the AI processing result. The predicted future health may be determined, for example, based on values predicted by the AI processing model. The predicted future health, in some examples, may be represented as an estimated number of days until recommended replacement of the docking station.

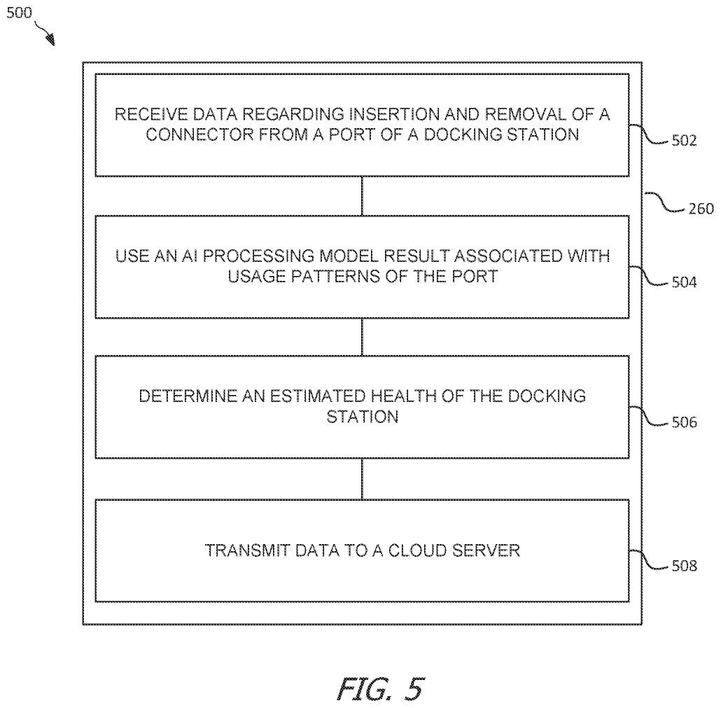

FIG. 5 is a flowchart of an example method 500 for dock health determination. In at least some examples, the method 500 is suitable for implementation on an electronic device, such as the electronic device 102 of the computing environment 100 of FIG. 1. For example, in at least some implementations the method 400 may be embodied as the dock health executable computer program product 260. Accordingly, the method 500 may be implemented as computer-executable instructions or code, stored on a computer-readable medium, such as the memory module 250 of FIG. 2, which, when executed by a processor such as the processor 230 of FIG. 2, causes the processor 230 to execute the computer-executable instructions to perform operations. The method 500 is implemented by the electronic device, in some examples, to determine a health of a docking station coupled to the electronic device.

At operation 502, the electronic device may receive data regarding insertion and removal of a connector from a port of a docking station. In at least some examples, based on the received data, the electronic device may derive or determine additional data. For example, the electronic device may determine a time at which the connector was inserted or removed, a number of times a connector has been inserted or removed from the port, usage statistics of the port, usage statistics of the docking station, etc.

At operation 504, the electronic device may use at least one AI processing model to process the received data to provide an AI processing model result associated with usage patterns of the port. In at least some examples, the AI processing model is a time series model, such as ARIMA. Based on the collected data, the AI process may determine predicted future values for the docking station.

At operation 506, the electronic device may determine an estimated health of the docking station based on the AI processing model result. In at least some examples, the estimated health is determined based on the predicted future values for the docking station. The estimated health may be represented, in some examples, on a scale from 0 to 100, where a value of 100 is considered a maximum health of the docking station (e.g., such as when the docking station is new and/or as of yet unused). In other examples, the estimated health may be represented as an estimated number of days until recommended replacement of the docking station.

At operation 508, the electronic device may transmit data including at least one of the received data, the AI processing model result, or the estimated health to a cloud server. The electronic device may transmit the data at a programmed interval, such as responsive to an occurrence of a particular trigger event, at a specified time, at an expiration of a programmed amount of time, etc. The electronic device may transmit the data to a cloud server or data store, such as that the data may be included in crowdsourced data as described herein.

The above discussion is meant to be illustrative of the principles and various examples of the present disclosure. Numerous variations and modifications are contemplated. It is intended that the following claims be interpreted to embrace all such variations and modifications.

What is claimed is:

1. An electronic device, comprising:
a processor to:
collect data of an input/output (I/O) interface of a docking station to which the electronic device is to couple;
use at least one artificial intelligence (AI) processing model to process the collected data of the I/O interface to provide an AI processing model result that calculates past usage and predicts future usage of the I/O interface; and
determine an estimated health of the docking station based on the AI processing model result.

2. The electronic device of claim 1, wherein the data of the I/O interface indicates whether or not a device is coupled to the I/O interface.

3. The electronic device of claim 2, wherein the data of the I/O interface includes both general attributes of a device coupled to the I/O interface and derived attributes determined based on the general attributes.

4. The electronic device of claim 1, wherein the estimated health of the docking station indicates an estimated number of days until recommended replacement of the docking station based on the predicted future usage of the I/O interface.

5. The electronic device of claim 1, wherein the AI processing model is a time series model.

6. An electronic device, comprising:
a processor to:
determine characteristics of an input/output (I/O) interface of a docking station to which the electronic device is coupled;
obtain crowdsourced data of other docking stations sharing at least one attribute with the docking station;
use at least one artificial intelligence (AI) processing model to process the determined characteristics of the I/O interface and the crowdsourced data to provide an AI processing model result that calculates past usage and predicts future usage of the I/O interface;
determine an estimated health of the docking station based on the AI processing model result; and
determine a predicted future health of the docking station based on the AI processing result.

7. The electronic device of claim 6, wherein the crowdsourced data includes data indicating characteristics of I/O interfaces of the other docking stations and future health of the other docking stations.

8. The electronic device of claim 6, wherein the AI processing model is an autoregressive fractionally integrated moving average model.

9. The electronic device of claim 6, wherein the predicted health of the docking station indicates an estimated number of days until recommended replacement of the docking station based on the predicted future usage of the I/O interface.

10. The electronic device of claim 6, wherein the determined characteristics of an I/O interface include general attributes of a device coupled to the I/O interface and derived attributes determined based on the general attributes, the derived attributes including at least a time at which the device was detected, a time at which the device was subsequently no longer detected, and usage statistics of the docking station.

11. A non-transitory computer-readable medium storing executable code, which, when executed by a processor of an electronic device, causes the processor to:
receive data regarding insertion and removal of a connector from a port of a docking station;
use at least one artificial intelligence (AI) processing model to process the received data to provide an AI processing model result associated with usage patterns of the port;
determine an estimated health of the docking station based on the AI processing model result; and
transmit data including at least one of the received data, the AI processing model result, or the estimated health to a cloud server.

12. The non-transitory computer-readable medium of claim 11, wherein the AI processing model is an autoregressive fractionally integrated moving average model.

13. The non-transitory computer-readable medium of claim 12, wherein the estimate health is determined on a scale of values, the scale including multiple ranges, each range corresponding to a recommendation associated with the docking station.

14. The non-transitory computer-readable medium of claim 13, wherein the electronic device determines an estimated number of days until recommended replacement of the docking station based on the predicted future usage of the port of the docking station.

15. The non-transitory computer-readable medium of claim 11, wherein the data regarding insertion and removal of the connector from the port of the docking station includes general attributes of a device coupled to the port of the docking station and derived attributes determined based on the general attributes, the derived attributes including at least a time at which the device was detected via insertion of the connector into the port, a time at which the device was subsequently no longer detected via removal of the connector from the port of the docking station, and usage statistics of all ports of the docking station.
